(19) United States
(12) Patent Application Publication
(10) Pub. No.: US 2004/0174087 A1
(43) Pub. Date: Sep. 9, 2004

(54) Stator

(76) Inventor: Markus Heidrich, Buehl (DE)

Correspondence Address: STRIKER, STRIKER & STENBY, 103 East Neck Road, Huntington, NY, 11743, US

(21) Appl. No.: 10/775,801

(22) Filed: Feb. 9, 2004

Related U.S. Application Data
(63) Continuation-in-part of application No. 10/031,829, filed on Jan. 22, 2002, now abandoned.
Application No. 10/031,829 is a 371 of international application No. PCT/DE01/01666, filed on May 4, 2001.

(30) Foreign Application Priority Data
May 6, 2000 (DE) 100 22 071.1

(51) Int. Cl. H02K 1/00; H02K 19/26; H02K 1/18; H02K 1/28

(52) U.S. Cl. 310/218; 310/194

(57) ABSTRACT

A stator for an electrical rotor motor has at least one stator pole tooth, a pole shoe, a coil body integrally extruded on the pole shoe, and at least one preassembled coil which is wound on the coil body and also slid onto the stator pole tooth and secured to the stator pole tooth by a unit of the pole shoe on which the coil body is integrally extruded.

### CROSS-REFERENCE TO A RELATED APPLICATION

This application is a continuation-in-part of application Ser. No. 10/031,829 filed on Jan. 22, 2002.

### BACKGROUND OF THE INVENTION

The invention is based on a stator.

A stator has already been made known in U.S. Pat. No. 5,089,730, onto the stator pole teeth of which a preassembled coil is slid. The coils are secured to the stator pole teeth by means of a single part.

This has the disadvantage, however, that a magnetic flux in the winding head of the exciting coil cannot be directed in defined fashion, and therefore does not contribute to the torque of the rotor, nor is there a gap in the foot of the tooth.

Some solutions are also disclosed in European patent document 0910152 and U.S. Pat. No. 2,189,524 and U.S. Pat. No. 5,852,335 as well as in German patent document DE 700420.

### SUMMARY OF THE INVENTION

Accordingly, it is an object of the present invention to provide a stator which is a further improvement of the existing stators.

In keeping with these objects and with others which will become apparent herein after, one feature of the present invention resides, briefly stated, in a stator for an electrical rotor motor, comprising at least one stator pole tooth; a pole shoe; a coil body integrally extruded on the pole shoe; and at least one preassembled coil which is wound on the coil body and also slid onto the stator pole tooth and secured to the stator pole tooth by means of the pole shoe on which the coil body is integrally extruded.

In contrast, the stator according to the invention has the advantage that a stator can be produced in simple fashion that makes smaller tolerances possible and has improved performance data, such as a higher slot fill factor of the excitation coils, less space required to install the motor, reduced stop torques, and higher torque, for example.

It is advantageous that a pole shoe is made of magnetically soft solid material, because a magnetic stray flux of a winding head of an exciting coil can then be directed in all spacial directions in defined fashion and contribute to the magnetic excitation.

It is further advantageous that a coil insulating frame is located on the pole shoe, because a coil can then be wound in simple fashion.

A coil can be electrically connected to an external power source or electrical control in advantageous fashion if an electrical connecting element is integrated in the coil insulating frame.

The novel features which are considered as characteristic for the present invention are set forth in particular in the appended claims. the invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a first exemplary embodiment of a stator designed according to the present invention;

FIG. 2 is a view showing a pole shoe of the stator in accordance with the present invention;

FIG. 3 is a view showing an oblong pole shoe of the stator in accordance with the present invention;

FIG. 4 is a view showing an oblong pole shoe having a coil frame, of the stator in accordance with the present invention.

### DESCRIPTION OF THE PREFERRED EMBODIMENTS

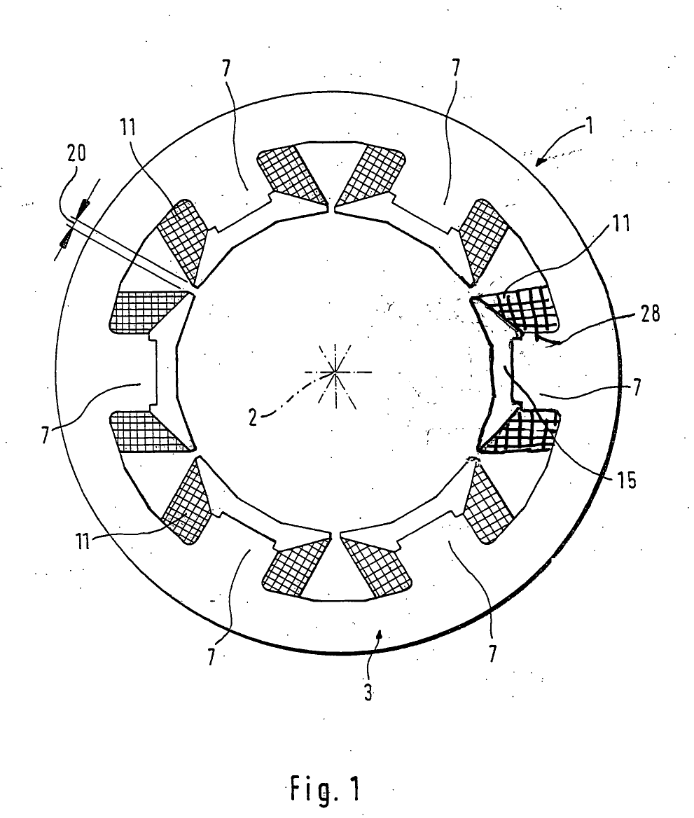

FIG. 1 shows a stator 1, according to the invention, of an electrical machine, such as an internal rotor motor, for example. The stator 1 is formed by a stator ring 3 that comprises at least one stator pole tooth 7 and a centerline 2. The stator ring 3 is made of a solid material, or it is laminated. The, e.g., six stator pole teeth 7 present, extending radially inward, are distributed evenly around the centerline 2.

A coil 11 is slid onto each stator pole tooth 7. These are preassembled coils 11, for example, e.g., “stoved-enamel” coils, or they are coils 11 wound onto a coil body 28. The coils 11 can also be compound coils.

Each coil 11 is secured to the stator pole tooth 7 by means of one pole shoe 15. Each exposed end of a stator pole tooth 7 and each pole shoe 15 is designed in such a fashion, for example, that a press fit is produced when joined. Any other type of mounting is feasible.

A stator 1 is achieved as a result, the inner diameter of which has a maximum tolerance of 0.05 mm between opposite pole shoes 15.

During assembly, the pole shoes 15 are placed on the stator pole teeth 7 and fixed sufficiently on the stator pole teeth 7 using a mandrel inserted in the direction of the centerline 2, and centered in relation to the centerline 2.

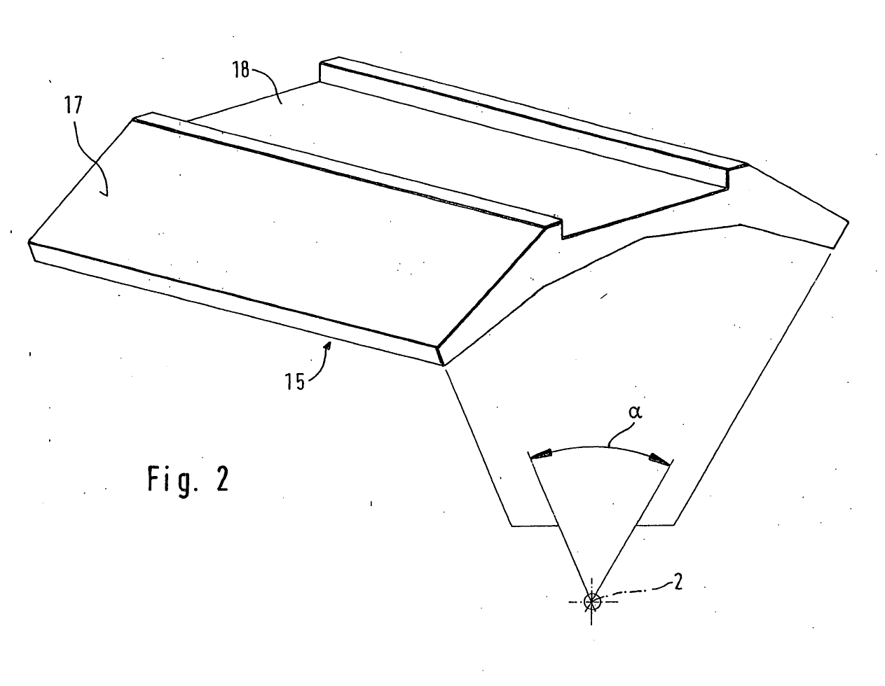

FIG. 2 shows a pole shoe 15. The pole shoe 15 comprises a groove 18 on an exterior surface 17, by means of which it is pressed onto the exposed end of the stator pole tooth 7, so that a press fit is produced. Magnetically soft material—“SMC” or “SMS” material—can be used as the material for the pole shoe 15 that is easy to manufacture and shape using pressing technology.

A stator according to the related art consists of stacks of individual laminations. It requires considerable expenditure to manufacture a laminated pole shoe out of individual laminations, however.

An opening angle □ encompassing the length of the pole shoe 15 in the circumferential direction around the centerline 2 can therefore be enlarged compared with the related art, which makes a gap in the foot of the tooth 20 (FIG. 1) smaller in size, and a stop torque for a transition between two detent positions is therefore reduced, because magnetic resistance is reduced due to a smaller gap in the foot of the tooth 20.

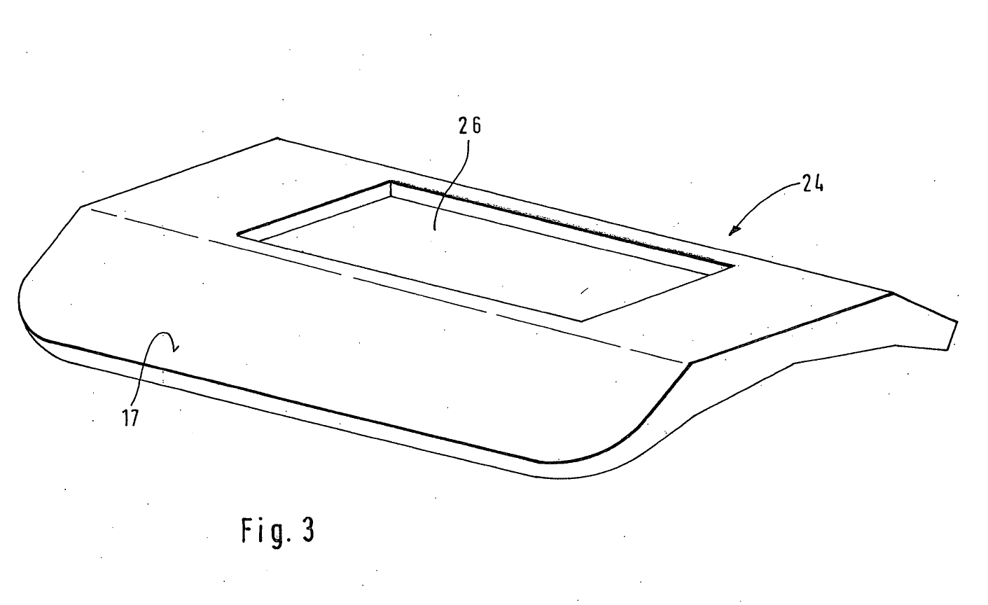

FIG. 3 shows an oblong pole shoe 24. The oblong pole shoe 24 is a pole shoe 15 that is longer in both axial directions than an exemplary embodiment according to FIG. 2, the groove 18 of which oblong pole shoe 24 is closed on both ends by the extension and forms an indentation 26.

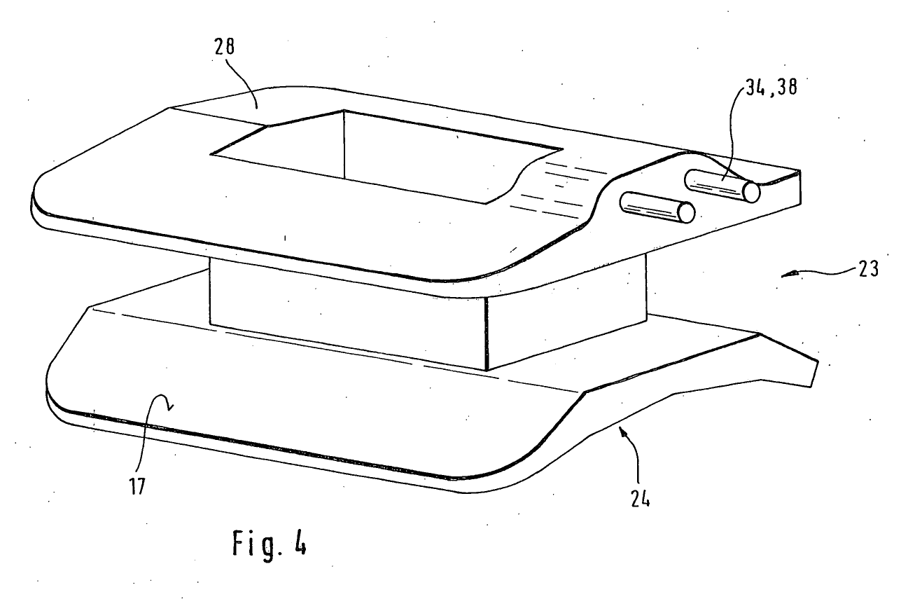

FIG. 4 shows an oblong pole shoe 24 on which the coil body 28 is located. The coil body 28 is integrally extruded on the oblong pole shoe 24 using plastic, for example. Undercuts, for example, are provided in the pole shoe 15 or the oblong pole shoe 24, i.e., a snap-in connection with the pole tooth 7 is formed, so that the coil body 28 is fixed in position on the pole tooth 7.

A coil 11 is wound on the coil body 28 that can be inspected before installation on the stator ring 3, i.e., only inspected coils 11 are installed. Therefore, a stator 1 that tests out poorly that comprises coils 11 wired together need not be thrown out entirely due to one bad coil 1.

One part of the coil 11 (not shown) in a winding head space 23 is located on one axial end of the coil body 28. The oblong pole shoe 24 makes it possible to direct a magnetic stray flux of an exciting coil 11 in defined fashion in the region of the winding head space 23 of the coil 11 as well, and therefore also contributes to the torque when a rotor is dimensioned accordingly.

The coil body 28 also provides electrical insulation for the coil 11 from the pole tooth 7 and/or the pole shoe 15 or the oblong pole shoe 24. The coil body 28 comprises at least one electrical connecting element 34 that serves to contact at least one end of a coil 11 with an external power supply. In this exemplary embodiment, the electrical connecting elements 34 are formed by two pins 38 located in the coil body 28. The electrical connecting element 34 can also be an insulation displacement connection.

It will be understood that each of the elements described above, or two or more together, may also find a useful application in other types of constructions differing from the types described above.

While the invention has been illustrated and described as embodied in, it is not intended to be limited to the details shown, since various modifications and structural changes may be made without departing in any way from the spirit of the present invention.

Without further analysis, the foregoing will reveal fully revela the gist of the present invention that others can, by applying current knowledge, readily adapt it for various applications without omitting features that, from the standpoint of prior art, fairly constitute essential characteristics of the generic or specific aspects of the invention.

What is claimed as new and desired to be protected by Letters Patent is set forth in the appended claims.

1. A stator (1) for an electrical rotor motor, comprising at least one stator pole tooth (7); a pole shoe (15); a coil body (28) integrally extruded on the pole shoe (15); and at least one preassembled coil (11) which is wound on the coil body (28) and also slid onto the stator pole tooth (7) and secured to the stator pole tooth (7) by means of the pole shoe (15) on which the coil body (28) is integrally extruded.

2. The stator according to claim 1, wherein the coil body (28) is located on the pole shoe (15).

3. The stator according to claim 1, wherein the pole shoe (15) is made of a magnetically soft solid material.

5. The stator according to claim 3, wherein the coil body (28) comprises at least one electrical connecting element (34).

6. The stator according to claim 5, wherein the electrical connecting element (34) is a pin (38).

7. The stator according to claim 1, wherein the pole shoe (15) is secured to the stator pole tooth (7) by means of press fit.
